(19) United States
(12) Patent Application Publication
(10) Pub. No.: US 2007/0138439 A1
(43) Pub. Date: Jun. 21, 2007

(54) Denaturant for ethanol

(75) Inventors: Robert A. Asmus, Hudson, WI (US); Beatrice C. Etzold, Hudson, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/314,761

(22) Filed: Dec. 21, 2005

(51) Int. Cl. C12F 5/00; B01F 1/00

(52) U.S. Cl. 252/366; 252/364; 252/365

(57) ABSTRACT

A denatured ethanol composition is provided, the composition consisting essentially of: ethanol and a denaturant selected from the group consisting of chlorhexidine and salts thereof, biguanide and combinations of two or more of the foregoing; and optionally, water.

The invention relates to ethanol comprising a denaturant and to products comprising the denatured ethanol.

### BACKGROUND

Ethyl alcohol or ethanol is used as an ingredient in any of a number of products that are not intended for consumption. In some products, ethanol is a solvent in which various compositional components are dissolved. Ethanol is often used in the preparation of cosmetics for its solvent properties, or in the formulation of sanitizing compositions for its antimicrobial properties, for example. Because such products are not intended to be ingested, the ethanol used in such products is typically denatured so that it is rendered undrinkable. Moreover, governmental authorities often impose taxes on commercial shipments of pure ethanol (e.g., 190 or 200 proof) even if the ethanol is intended for industrial uses such an ingredient in the aforementioned cosmetic or antimicrobial products.

A number of materials are available for denaturing ethyl alcohol including methanol, isopropanol, iodine, formaldehyde solution, phenylethyl alcohol, chloroform and diethyl phthalate. The known denaturants have several disadvantages that can lower the quality of the product they are associated with. Diethyl phthalate, for example, is known to cause sneezing when used in aerosol formulations. Other denaturants, such as isopropanol and methyl isobutyl ketone, influence the odor character of perfumed products and some of them are known to be color-unstable. Some denaturants (e.g., methanol, iodine, formaldehyde, chloroform) are potentially hazardous to handle and can be toxic if consumed.

### SUMMARY

The present invention provides a composition in the form of a denatured alcohol. In a first aspect, the composition consists essentially of:

Ethanol;

A denaturant selected from the group consisting of chlorhexidine and salts thereof, biguanide and combinations of two or more of the foregoing; and

Optionally, water.

In another aspect, the invention provides a composition that consists essentially of:

Ethanol;

Chlorhexidine Gluconate; and

Optionally, water.

Those skilled in the art will further appreciate the various aspects of the invention upon reviewing the remainder of the disclosure, including the detailed description of the various embodiments and the appended claims.

### DETAILED DESCRIPTION

The present invention provides materials suitable for use as ethanol denaturants. The materials described herein, while useful as denaturants, do not possess the hazardous properties of denaturants that are already known and used. Moreover, denatured alcohol of the invention can be incorporated into other compositions in which the denatured alcohol will provide additional antimicrobial or antiseptic character.

Denaturants suitable for use in the present invention include chlorhexidine and salts thereof. Suitable chlorhexidine salts include without limitation chlorhexidine gluconate, chlorhexidine lactate, chlorhexidine acetate, chlorhexidine isobutyrate, chlorhexidine glucoheptonate, chlorhexidine methanesulphonate and chlorhexidine hydrochloride. Other suitable denaturants include biguanides such as metformin hydrochloride as well as alexidine salts (1,1′-Hexamethylene-bis[5-(2-ethylhexyl)biguanide]) such as alexidine dihydrochloride, alexidine dihydrofloride and alexidine diacetate. Combinations of two or more of the foregoing denaturants are also contemplated.

In embodiments of the invention, chlorhexidine gluconate (“CHG”) is used as the denaturant without adding to the safety hazards of the alcohol to those in the workplace or to a potential abuser. CHG is often used as an antiseptic agent. While CHG has been used in cleansers, for surgical scrubs, for treating skin wounds, as a germicidal hand rinse and as an antibacterial dental rinse, it has previously been unrecognized as a denaturant for ethanol. CHG is well suited as a denaturant because it is highly soluble in alcoholic solutions, has a low toxicity and possesses an ability to bind to mucosal tissues in the mouth to provide a persistently unpleasant bitter taste.

In the foregoing embodiments, CHG as well as other chlorhexidine salts can be used as a denaturant while also providing additional benefits as an antimicrobial and preservative. Thus, the chlorhexidine salts are useful in first providing utility as a denaturant and thereafter being useful as an antimicrobial in a composition that incorporates the denatured ethanol as a component. In other words, compositions that include ethanol and CHG, for example, as individual components, could be formulated with denatured alcohol as a source for the ethanol and the CHG components.

In embodiments of the invention, biguanide compounds are used for denaturing ethanol. Biguanides also exhibit germicidal and antimicrobial activities. With certain types of substituents, the compositions are also useful as components of hair-care products and other items of personal hygiene.

In addition to providing a bitter and unpleasant taste, the denaturants described herein can, upon repeated exposure, stain or discolor teeth, and simple tooth brushing is generally ineffective in removing the stain. This additional effect provides another incentive to not abuse alcohol products denatured with these agents, and it potentially serves as an indicator of those who have abused the denatured alcohol.

The compositions according to the invention can be prepared by mixing the individual components. Denaturants used in the present invention can be added to 190 to 200 proof ethanol to provide a final denaturant concentration of at least about 0.01% by weight. In some embodiments, the concentration of the denaturant may be within the range from about 0.01% to about 20 % by total weight. In other embodiments, the final denaturant concentration may fall within the range from about 0.08 % to about 1.5% by total weight. The determination of the fitness (or unfitness) of an ethanol/denaturant solution according to the present invention may be made according to the methods set forth, for example, in 27 CFR 17.134 which provides, in part, that a product's unfitness for beverage purposes may be determined by organoleptic examination. In such an examination, the product may be diluted with water to an alcoholic concentration of 15% and tasted. Other methods for the determination of a products fitness for beverage purposes may also be employed.

The denatured ethanol of the invention can be further used in the preparation of other products that require ethanol and the denaturant as components thereof. These products may comprise from 1 to 99% by weight of the denatured ethanol. In some embodiments, the denatured alcohol may be a component in a sanitizing lotion, for example, that requires ethanol and denaturant, although the denaturant may be required for its antimicrobial properties in the sanitizing lotion. In some embodiments, the denatured alcohol may be a component in a cosmetic product that requires ethanol and denaturant, although the denaturant may be useful for its antimicrobial properties in the cosmetic. In formulating these other products, the denatured alcohol may simply be added to the other components of the product formulation to provide the ethanol and denaturant at concentrations needed for the particular product. Those skilled in the art will appreciate that the concentration of the denaturant in the ethanol composition may be supplemented with additional denaturant to bring the concentration of the denaturant to the level needed for antimicrobial efficacy, for example.

### EXAMPLES

Additional features of the embodiments of the invention are further described in the following non-limiting examples. Unless indicated otherwise, all parts and percentages are on a weight basis.

Components used in formulations described in the various Examples are listed in Table 1.

TABLE 1
Components

| Component | Supplier/Vendor | Supplier Location |
|---|---|---|
| 20% B.P.¹ chlorhexidine | Xttrium Laboratories | Chicago, IL |
| gluconate (CHG) solution | | |
| 190 proof USP Ethyl | Aaper Alcohol | Shelbyville, KY |
| Alcohol (92.4 w/w % ethyl | | |
| alcohol and 7.6 w/w % | | |
| water) | | |
| Glycerol | Dow Chemical | Midland, MI |
| PEG 600 | Dow Chemical | Midland, MI |
| PEG 900 | Dow Chemical | Midland, MI |

¹British Pharmacopoeia

### Examples 1-3, Comparative Examples A, B and C

The ethanol solutions of Examples 1-4 and Comparative Examples A and B were prepared by adding the components listed in Table 1 according to the amounts listed in Table 2 to a clean glass container. The solutions were mixed by shaking. A determination of unfitness for beverage purposes was made for each of the ethanol solutions by organoleptic examination, as described in 27 CFR 17.134, by tasting samples of the product diluted with water to an alcohol concentration of 15% by volume. Two individuals, one male, one female, tasted 0.5 grams of each of the ethanol solutions to demonstrate the effectiveness of the identified denaturant.

The compositions and the taste observations of the various ethanol solutions are set forth in Table 2.

TABLE 2
Examples 1-3 and Comparative Examples A, B and C

| | | Final | | |
|---|---|---|---|---|
| | | Amount of | | |
| | | Denaturant | | |
| | | after dilution | | Taste |
| Example | Composition | % w/w | | Observation |
| Comparative | 39.40 grams of 190 | None | | Alcohol taste |
| Example A | proof USP ethanol + | | | |
| | 260.60 grams of | | | |
| | purified water | | | |
| Example 1 | 14.92 grams of | 0.1% | CHG | Putrid, bitter, |
| | Comparative | | | awful taste. |
| | Example A + 0.079 | | | Taste persisted |
| | grams of 20% CHG | | | for several |
| | | | | hours |
| Example 2 | 7.50 grams of | 0.05% | CHG | Strong bitter, |
| | Comparative | | | awful taste. |
| | Example A + 7.50 | | | Persistant |
| | grams of Example 1 | | | taste that |
| | | | | felt like it |
| | | | | coated the |
| | | | | tongue. |
| Example 3 | 13.50 grams of | 0.01% | CHG | Weak bitter |
| | Control Example A + | | | taste that |
| | 1.50 grams of | | | seemed to |
| | Example 2 | | | build in un- |
| | | | | pleasantness |
| | | | | over time. |
| Comparative | 13.50 grams of | 0.001% | CHG | Alcohol taste |
| Example B | Comparative | | | |
| | Example A + 1.50 | | | |
| | grams of Example 3 | | | |
| Comparative | 14.95 grams of | 0.34% | Glycol | Alcohol taste |

| | | |
|---|---|---|
| Example C | Comparative | (combined) |
| | Example A + 0.01 | |
| | grams of Glycerol + | |
| | 0.01 grams of PEG | |
| | 600 + 0.01 grams of | |
| | PEG 900 | |

### Examples 4-6

The Examples presented in Table 3 represent the amounts and concentrations for the process of denaturing 100 gallons (378.5 liters) of 190 proof ethanol (“EtOH”) at three different levels of CHG. For instance, Example 6 was prepared by adding 1.23 kg of 20% w/v CHG to 100 gallons (378.5 liters) of 190 proof ethanol. This resulted in a solution of denatured ethanol with 285 kg pure ethanol, 24.3 kg of water and a concentration of 0.08% w/w CHG. If the ethanol solutions of Examples 4-6 were diluted down to 15% v/v ethanol as permitted under 27 CFR 17.134 (“Determination of unfitness for beverage purposes”), the resulting CHG concentrations in the diluted solutions would be 0.10% w/w, 0.05% w/w and 0.01% w/w, respectively.

TABLE 3
Examples Denatured Ethanol Formulations

| | 190 | Amount of | | | | | | % CHG if |
|---|---|---|---|---|---|---|---|---|
| | Proof | 20% w/v | EtOH | Water | Final | Final | Final | diluted to |
| Ex. | EtOH | CHG added | Weight | Weight | EtOH | CHG | Water | 15% v/v |
| No. | (liters) | (kg) | (kg) | grams | % w/w | % w/w | % w/w | EtOH |
| 4 | 378.5 | 12.3 | 285 | 33.3 | 88.88 | 0.72 | 10.40 | 0.10 |
| 5 | 378.5 | 6.17 | 285 | 28.3 | 90.63 | 0.37 | 9.00 | 0.05 |
| 6 | 378.5 | 1.23 | 285 | 24.3 | 92.07 | 0.08 | 7.85 | 0.01 |

The present invention has been described with reference to embodiments thereof. It will be apparent by those skilled in the art that changes, modifications or additions can be made to the described embodiments without departing from the scope of the present invention.

What is claimed:

1. A composition, consisting essentially of:
ethanol;
a denaturant selected from the group consisting of chlorhexidine and salts thereof, biguanide and combinations of two or more of the foregoing; and
optionally, water.

2. The composition of claim 1 wherein the chlorhexidine salts are selected from the group consisting of chlorhexidine gluconate, chlorhexidine lactate, chlorhexidine acetate, chlorhexidine isobutyrate, chlorhexidine glucoheptonate, chlorhexidine methanesulphonate, chlorhexidine hydrochloride and combinations of two or more of the foregoing.

3. The composition of claim 1 wherein the biguanide is selected from the group consiting of metformin hydrochloride, alexidine salts and combinations of two or more of the foregoing.

4. The composition of claim 3 wherein the alexidine salts are selected from the group consisting of alexidine dihydrochloride, alexidine dihydrofloride, alexidine diacetate and combinations of two or more of the foregoing.

5. The composition of claim 1 wherein the denaturant is present in the composition at a concentration of at least about 0.01% by weight.

6. The composition of claim 1 wherein the denaturant is present in the composition at a concentration in the range between 0.01% and 20% by weight.

7. The composition of claim 1 wherein the denaturant is present in the composition at a concentration in the range between 0.08% and 1.5% by weight.

8. A composition, consisting essentially of:
ethanol;
chlorhexidine gluconate; and
optionally, water.

9. The composition of claim 8 wherein the chlorhexidine gluconate is present in the composition at a concentration of at least about 0.01% by weight.

10. The composition of claim 8 wherein the chlorhexidine gluconate is present in the composition at a concentration in the range between 0.01% and 20% by weight.

11. The composition of claim 8 wherein the chlorhexidine gluconate is present in the composition at a concentration in the range between 0.08% and 1.5% by weight.
